(19) United States
(12) Patent Application Publication
(10) Pub. No.: US 2025/0117500 A1
(43) Pub. Date: Apr. 10, 2025

(54) SYSTEM FOR READING AN ENCRYPTION/DECRYPTION KEY AND ASSOCIATED METHOD

(71) Applicant: STMicroelectronics International N.V., Geneva (CH)

(72) Inventors: Jean-Michel GRIL-MAFFRE, Aix-en-Provence (FR); Christophe EVA, Rousset (FR)

(21) Appl. No.: 18/896,096

(22) Filed: Sep. 25, 2024

(30) Foreign Application Priority Data
Oct. 9, 2023 (FR) 2310780

(51) Int. Cl. G06F 21/60

(52) U.S. Cl. CPC G06F 21/602; G06F 21/604

(57) ABSTRACT

The present disclosure provides a system and method for reading an encryption/decryption key. An example includes at least one first word comprising a plurality of bits, with the system including: a first comparison means, a first delivery means, a second comparison means, and a second delivery means.

### CROSS REFERENCE TO RELATED APPLICATION(S)

This application claims the priority benefit of French patent application number FR2310780, filed on Oct. 9, 2023, entitled “Systeme De Lecture D'une Cle De Chiffrement/Dechiffrement Et Procede Associe,” which is hereby incorporated by reference to the maximum extent allowable by law.

### TECHNICAL FIELD

Embodiments and implementations relate to reading of an encryption/decryption key stored in a memory, in particular securing reading of the key.

### BACKGROUND

FIG. 1 schematically illustrates an example of a backup system of a key used for example for encryption/decryption operations as known from the prior art.

The backup system comprises a first memory 1 storing an encryption/decryption key 2 including bits B₁, B₂, B₃, B₁₂₇, B₁₂₈.

For example, the key 2 includes one hundred twenty-eight bits.

The system further includes as many multiplexers M1, M2, M3, M127, M128 as bits in the key 2.

Each multiplexer M1, M2, M3, M127, M128 comprises a first input connected to the first memory 1 to read a bit B₁, B₂, B₃, B₁₂₇, B₁₂₈ of the key 2 and a second input connected to a low logic state, for example a “0” Boolean.

Each multiplexer M1, M2, M3, M127, M128 further comprises a control input connected to an output of a comparator 3 and an output connected to a first register 4.

The system further includes a second memory 5 storing an access key 6 including a series of bits B₁₁, B₁₂, B₁₈ and a second register 7 storing a word 8 including a series of bits B₂₁, B₂₂, B₂₈.

For example, the word 8 is delivered by a bus connected to the second register 7 when an access to the encryption/decryption key 2 is required.

When the bits B₂₁, B₂₂, B₂₈ contained in the second register 7 are identical to the access key 6, the comparator 3 delivers a high logic state on its output so that each multiplexer M1, M2, M3, M127, M128 delivers on its output a bit B₁, B₂, B₃, B₁₂₇, B₁₂₈ of the encryption/decryption key 2, the bits delivered by the multiplexers M1, M2, M3, M127, M128 being stored in the register 4 for a subsequent use of the encryption/decryption key 2 stored in the first register 4.

When at least one of the bits B₂₁, B₂₂, B₂₈ contained in the second register 7 is different from the bits B₁₁, B₁₂, B₁₈ of the access key 6, the comparator 3 delivers a low logic state on its output so that each multiplexer M1, M2, M3, M127, M128 delivers on its output a bit at the low state “0” allowing deducing that the word stored in the second register 7 does not enable reading of the encryption/decryption key 2. The observation of the output of the multiplexers M1, M2, M3, M127, M128 allows deducing that they do not deliver bits of the encryption/decryption key 2.

Since all of the multiplexers M1, M2, M3, M127, M128 are controlled by the comparator 3, all it needs is to conduct an attack implementing for example a laser directed on the output of the comparator 3 or on a track connecting the output of the comparator 3 to the multiplexers M1, M2, M3, M127, M128 to force a high logic state at the control input of the multiplexers M1, M2, M3, M127, M128 so that the multiplexers M1, M2, M3, M127, M128 deliver the encryption/decryption key 2 on their output.

Thus, there is a need to provide key reading systems that are resistant to attacks implementing a laser.

### BRIEF SUMMARY

The implementations and embodiments defined hereinafter, are provided with that in view, and enable a reading system not to deliver the encryption/decryption key during an attack implementing a laser.

According to one aspect, a method is provided for reading an encryption/decryption key including at least one first word comprising a plurality of bits, the method including:
a first comparison of a first set of bits of an unlocking word including a plurality of bits and of a first set of bits of an access key, the first set of bits of the access key including at least one first bit of the plurality of bits of the access key,
delivering at least one first set of bits of the first word of the encryption/decryption key if the first set of bits of the unlocking word is identical to the first set of bits of the access key, the first set of bits being selected from among the plurality of bits of the first word,
at least one second comparison of a second set of bits of the unlocking word different from the first set of bits of the unlocking word and of a second set of bits of the access key, the second set of bits of the access key including at least one second bit of the plurality of bits of the access key different from the first bit, and
delivering at least one second set of bits of the first word of the encryption/decryption key if the second set of bits of the unlocking word is identical to the second set of bits of the access key, the second set of bits being selected from among the plurality of bits of the first word and different from the bits of the first set of bits, the combination of the sets of bits of the first word forming the first word.

To obtain the entirety of the encryption/decryption key, it is necessary to meet two different conditions. It is necessary that the first set of bits of the unlocking word is identical to the first set of bits of the access key to obtain a first portion of the key and it is necessary that the second set of bits of the unlocking word is identical to the second set of bits of the access key to obtain a second portion of the key.

During an attack, it is necessary to implement two lasers to force the delivery of the key by the first and second delivery means thereby making the reading system more robust in comparison with a reading system known from the prior art.

According to one implementation, the encryption/decryption key includes at least one second word comprising a plurality of bits, the method includes:
delivering at least one first set of bits of the second word of the encryption/decryption key when the first set of bits of the unlocking word is identical to the first set of bits of the access key, the first set of bits of the second word being selected from among the plurality of bits of the second word, and
delivering at least one second set of bits of the second word of the encryption/decryption key if the second set of bits of the unlocking word is identical to the second set of bits of the access key, the second set of bits of the second word being selected from among the plurality of bits of the second word and different from the bits of the first set of bits of the second word, the combination of the sets of bits of the second word forming the second word and the first and second words forming the encryption/decryption key.

According to one implementation, the bits of at least one set of bits of the encryption/decryption key are selected so that the bits do not follow one another.

According to one implementation, when a set of bits of the unlocking word is not identical to a set of bits of the access key, the method includes delivering a set of predetermined bits having the same size as the set of bits associated with the comparison.

According to one implementation, the first set of bits of the access key includes the first bit of the access key and a first combination of bits selected from among the plurality of bits of the access key, the bits of the first combination being different from the first and second bits of the access key, and the second set of bits of the access key includes the second bit and a second combination of bits selected from among the plurality of bits of the unlocking word, the bits of the second combination being different from the first bit, from the second bit and from the bits of the first combination.

According to another aspect, a system is also provided for reading an encryption/decryption key including at least one first word comprising a plurality of bits, the system including:
a first comparison means configured to compare a first set of bits of an unlocking word including a plurality of bits and of a first set of bits of an access key, the first set of bits of the access key including at least one first bit of the plurality of bits of the access key,
a first delivery means configured to deliver at least one first set of bits of the first word of the encryption/decryption key if the first set of bits of the unlocking word is identical to the first set of bits of the access key, the first set of bits being selected from among the plurality of bits of the first word,
a second comparison means configured to compare a second set of bits of the unlocking word different from the first set of bits of the unlocking word and of a second set of bits of the access key, the second set of bits of the access key including at least one second bit of the plurality of bits of the access key different from the first bit, and
a second delivery means configured to deliver at least one second set of bits of the first word of the encryption/decryption key if the second set of bits of the unlocking word is identical to the second set of bits of the access key, the second set of bits being selected from among the plurality of bits of the first word and different from the bits of the first set of bits, the combination of the sets of bits of the first word forming the first word.

According to one embodiment, the encryption/decryption key includes at least one second word comprising a plurality of bits, the system including:
a third delivery means configured to deliver at least one first set of bits of the second word of the encryption/decryption key if the first set of bits of the unlocking word is identical to the first set of bits of the access key, the first set of bits being selected from among the plurality of bits of the first word, and
a fourth delivery means configured to deliver at least one second set of bits of the second word of the encryption/decryption key if the second set of bits of the unlocking word is identical to the second set of bits of the access key, the second set of bits being selected from among the plurality of bits of the first word and different from the bits of the first set of bits, the combination of the sets of bits of the second word forming the first word.

According to one embodiment, the bits of at least one set of bits of the encryption/decryption key are selected so that the bits do not follow one another.

According to one embodiment, at least one delivery means is configured to deliver a set of predetermined bits when the set of bits of the unlocking word associated with the delivery means is not identical to a set of bits of the access key, the set of predetermined bits having the same size as the set of bits associated with the comparison.

According to one embodiment, the first set of bits of the access key includes the first bit of the access key and a first combination of bits selected from among the plurality of bits of the access key, the bits of the first combination being different from the first and second bits of the access key, and the second set of bits of the access key includes the second bit and a second combination of bits selected from among the plurality of bits of the unlocking word, the bits of the second combination being different from the first bit, from the second bit and from the bits of the first combination.

### BRIEF DESCRIPTION OF THE DRAWINGS

Other advantages and features of the present disclosure will appear upon examining the detailed description of non-limiting embodiments and implementations, and from the appended drawings, wherein:

FIG. 1 illustrates a system for reading a key according to the prior art, and

FIG. 2 and FIG. 3 illustrate embodiments and implementations of the present disclosure.

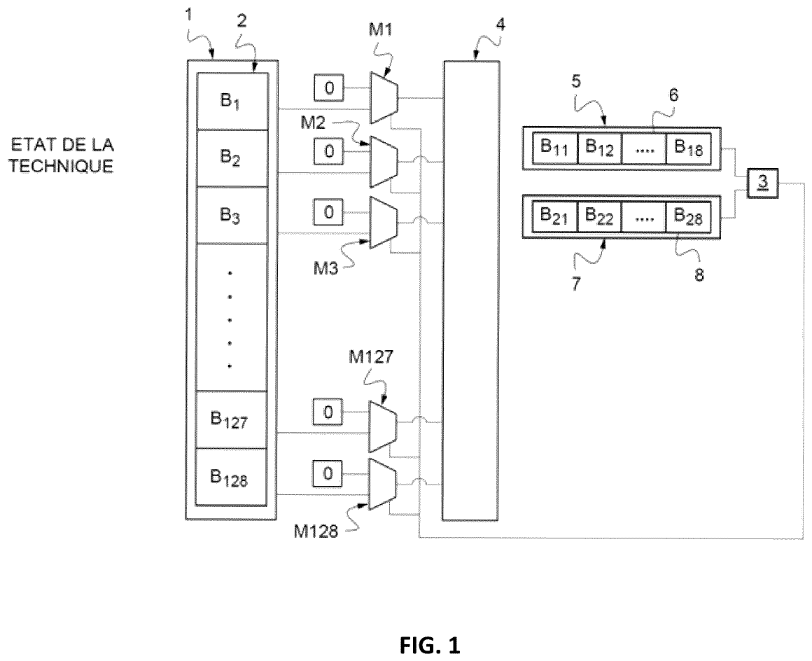

### DETAILED DESCRIPTION

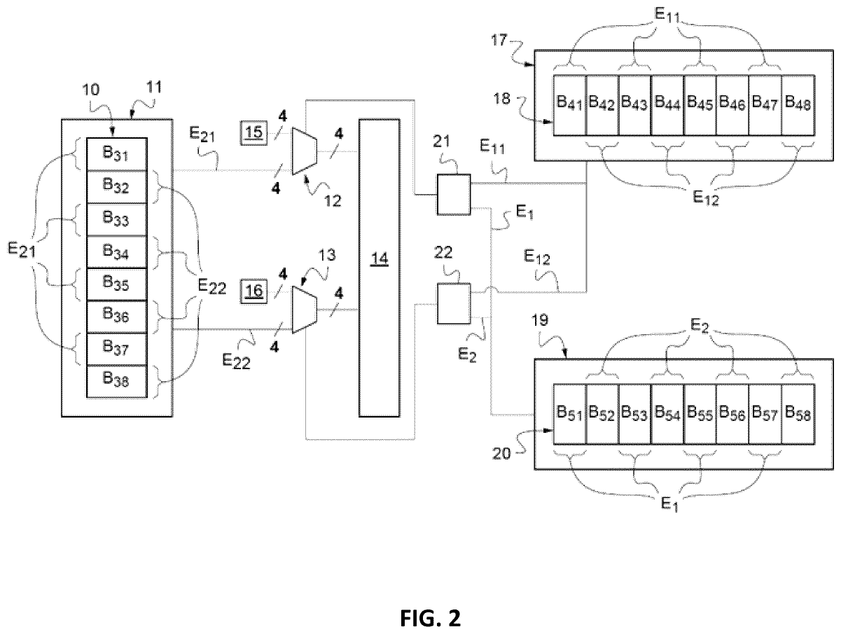

FIG. 2 illustrates a first embodiment of a system for reading an encryption/decryption key 10.

For clarity, it is assumed in this example that the encryption/decryption key 10 includes a first word with eight bits B₃₁ to B₃₈.

The first word forms the encryption/decryption key 10.

The encryption/decryption key 10 is stored in a first memory 11 connected to a first delivery means 12 and to a second delivery means 13.

Each delivery means 12, 13 includes a first input connected to the first memory 11, a second input and an output connected to a first register 14.

The second input of the first delivery means 12 is for example connected to a third memory 15 and the second input of the second delivery means 13 is for example connected to a fourth memory 16.

As illustrated, each delivery means 12, 13 includes for example a multiplexer including a first input connected to the first input of the delivery means 12, 13, a second input connected to the second input of the delivery means 12, 13, and an output connected to the output of the delivery means 12, 13.

Alternatively, each delivery means 12, 13 may be made from logic gates.

The system further includes a fourth memory 17 storing an access key 18 including for example eight bits B₄₁ to B₄₈, a second register 19 storing an unlocking word 20 including the same number of bits B₅₁ to B₅₈ as the access key 18.

The system further includes a first comparison means 21 and a second comparison means 22.

For example, each comparison means 21, 22 includes a comparator made from logic gates.

A first input of each comparison means 21, 22 is connected to the fourth memory 17 and a first input of each comparison means 21, 22 is connected to the second register 19.

An output of the first comparison means 21 is connected to a control input of the first delivery means 12 and an output of the second comparison means 22 is connected to a control input of the second delivery means 13.

A method for implementing the first example of the reading system is now described.

When the unlocking word 20 is stored in the second register 19, the first comparison means 21 compares a first set E1 of bits of the unlocking word 20 and a first set E11 of bits of the access key 18, and the second comparison means 22 compares a second set E2 of bits of the unlocking word 20 and a second set E12 of bits of the access key 18.

The first set E1 of bits of the unlocking word 20 comprises at least one first bit of the plurality of the bits of the unlocking word 20 and the first set E11 of bits of the access key 18 comprises at least one first bit of the plurality of the bits of the access key 18.

The second set E2 of bits of the unlocking word 20 comprises at least one second bit of the plurality of the bits of the unlocking word 20 different from the first bit of the unlocking word 20 and the second set E12 of bits of the access key 18 comprises at least one second bit of the plurality of the bits of the access key 18 different from the first bit of the access key 18.

If the first set of bits E1 of the unlocking word 20 is identical to the first set E11 of bits of the access key 18, the first comparison means 21 controls the first delivery means 12 so that it delivers a first set E21 of bits of the first word of the encryption/decryption key 10.

For example, the first set E21 of bits of the delivered first word of the encryption/decryption key 10 is stored in the first register 14.

Similarly, if the second set of bits E2 of the unlocking word 20 is identical to the second set E12 of bits of the access key 18, the second comparison means 22 controls the second delivery means 13 so that it delivers a second set E22 of bits of the first word of the encryption/decryption key 10.

For example, the second set E22 of bits of the delivered first word of the encryption/decryption key 10 is stored in the first register 14.

The first set E21 of bits of the first word of the encryption/decryption key 10 and the second set E22 of bits of the first word of the encryption/decryption key 10 form the encryption/decryption key 10.

To obtain the entirety of the encryption/decryption key 10, it is necessary to meet two different conditions. It is necessary that the first set of bits E1 of the unlocking word 20 is identical to the first set E11 of bits of the access key 18 to obtain a first portion of the key 10 and it is necessary that the second set of bits E2 of the unlocking word 20 is identical to the second set E12 of bits of the access key 18 to obtain a second portion of the key 10.

During an attack, it is necessary to implement two lasers to force the delivery of the key 10 by the first and second delivery means thereby making the reading system robust in comparison with a reading system known from the prior art.

In order to further secure the reading system, the first set E11 of bits of the access key 18 includes the first bit and a first combination of bits selected from among the plurality of bits of the unlocking word, and the second set E12 of bits of the access key 18 includes the second bit and a second combination of bits selected from among the plurality of bits of the unlocking word.

The bits of the second combination are different from the first bit, from the second bit and from the bits of the first combination.

In addition, it is possible that the bits of the first combination do not follow one another and it is possible that the bits of the second combination do not follow one another.

For example, the first set E11 of bits of the access key 18 includes the first bit B₄₁ and the first combination of bits includes the bits B₄₃, B₄₅, B₄₇, and the second set E12 of bits of the access key 18 includes the second bit B₄₂ and the first combination of bits includes the bits B₄₄, B₄₆, B₄₈.

In order to further secure the reading system during an attack when one of the delivery means 12, 13 is forced to deliver the first set E21 of bits of the first word of the encryption/decryption key 10 or the second set E22 of bits of the first word of the encryption/decryption key 10, the bits of the first and second sets E21, E22 of bits of the first word of the encryption/decryption key 10 do not follow one another so that the order of the bits obtained by the attack does not correspond to the order of the bits in the encryption/decryption key 10.

Of course, alternatively, only the bits of one of the first and second sets E21, E22 of bits of the first word of the encryption/decryption key 10 could be not following one another.

For example, the first set E21 of bits of the first word of the encryption/decryption key 10 comprises the bits B₃₁, B₃₃, B₃₅, B₃₇, and the second set E22 of bits of the first word of the encryption/decryption key 10 comprises the bits B₃₂, B₃₄, B₃₆, B₃₈.

When the first set E1 of bits of the unlocking word 20 is not identical to the first set E11 of bits of the access key 18, the first comparison means 21 may control the first delivery means 12 so that it delivers a set of predetermined bits stored in the third memory 15.

The set of predetermined bits includes the same number of bits as the number of bits contained in the first set E21 of bits of the first word of the encryption/decryption key 10 so that it has the same size as that of the first set E21. Each bit of the set of predetermined bits is in a high or low logic state so that when the first set E1 of bits of the unlocking word 20 is not identical to the first set E11 of bits of the access key 18, the set of delivered predetermined bits is like a portion of the encryption/decryption key 10 misleading a hacker observing the output of the first delivery means 12.

Similarly, when the second set E2 of bits of the unlocking word 20 is not identical to the second set E12 of bits of the access key 18, the second comparison means 22 may control the second delivery means 13 so that it delivers a set of predetermined bits stored in the fourth memory 16. The set of delivered predetermined bits is like another portion of the encryption/decryption key 10 misleading a hacker observing the output of the second delivery means 13.

Of course, the first word may comprise more or less eight bits.

Alternatively, the encryption/decryption key 10 may be formed of several words.

Alternatively, the access key may comprise more or less eight bits.

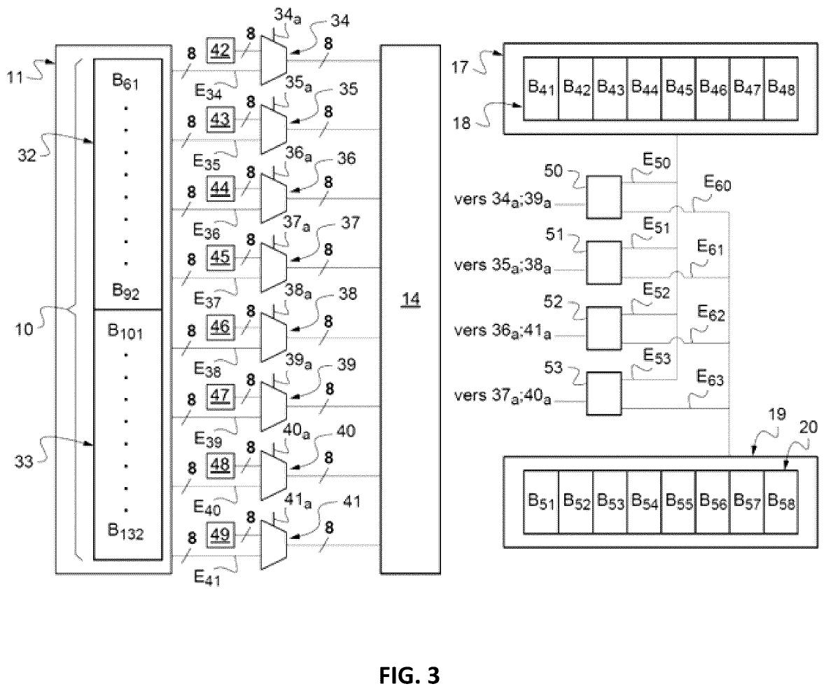

FIG. 3 illustrates a second embodiment of a system for reading an encryption/decryption key 10.

One could find the first memory 11, the first register 14, the fourth memory 17 storing the access key 18 including eight bits B₄₁ to B₄₈, and the second register 19 storing the unlocking word 20 including the bits B₅₁ to B₅₈.

In this embodiment, it is assumed that the encryption/decryption key 10 is formed by a first word 32 including for example thirty-two bits referenced B₆₁ to B₉₂ and a second word 33 for example with thirty-two bits referenced B₁₀₁ to B₁₃₂ stored in the first memory 11.

The first and second words 32, 33 are stored in the first memory 11.

The encryption/decryption key 10 includes sixty-four bits.

The reading system includes a first set of delivery means to deliver the bits B₆₁ to B₉₂ of the first word 32, a second set of delivery means to deliver the bits B₁₀₁ to B₁₃₂ of the second word 33.

For example, the first set of delivery means includes a first delivery means 34, a second delivery means 35, a third delivery means 36 and a fourth delivery means 37.

For example, the second set of delivery means includes a third delivery means 38, a fourth delivery means 39, a first delivery means 40 and a second delivery means 41.

Each delivery means 34, 35, 36, 37, 38, 39, 40, 41 includes a first input connected to the first memory 11, a second input, an output connected to the first register 14 and a control input 34a, 35a, 36a, 37a, 38a, 39a, 40a, 41a.

The second input of the first delivery means 34 of the first set of delivery means is connected to a fifth memory 42, the second input of the second delivery means 35 of the first set of delivery means is connected to a sixth memory 43, the second input of the third delivery means 36 of the first set of delivery means is connected to a seventh memory 44 and the second input of the fourth delivery means 37 of the first set of delivery means is connected to an eighth memory 45.

The second input of the third delivery means 38 of the second set of delivery means is connected to a ninth memory 46, the second input of the fourth delivery means 39 of the second set of delivery means is connected to a tenth memory 47, the second input of the first delivery means 40 of the second set of delivery means is connected to an eleventh memory 48 and the second input of the second delivery means 41 of the second set of delivery means is connected to a twelfth memory 49.

As illustrated, each delivery means 34, 35, 36, 37, 38, 39, 40, 41 includes for example a multiplexer including a first input connected to the first input of the delivery means 34, 35, 36, 37, 38, 39, 40, 41, a second input connected to the second input of the delivery means 34, 35, 36, 37, 38, 39, 40, 41, and an output connected to the output of the delivery means 34, 35, 36, 37, 38, 39, 40, 41.

The reading system further includes a first comparison means 50, a second comparison means 51, a third comparison means 52 and a fourth comparison means 53.

Each comparison means 50, 51, 52, 53 includes a first input connected to the fourth memory 17, a second input connected to the second register 19 and an output.

The output of the first comparison means 50 is connected to the control input 34a of the first delivery means 34 of the first set of delivery means and connected to the control input 39a of the fourth delivery means 39 of the second set of delivery means.

The output of the second comparison means 51 is connected to the control input 35a of the second delivery means 35 of the first set of delivery means and connected to the control input 38a of the third delivery means 38 of the second set of delivery means.

The output of the third comparison means 52 is connected to the control input 36a of the third delivery means 36 of the first set of delivery means and connected to the control input 41a of the second delivery means 41 of the second set of delivery means.

The output of the fourth comparison means 53 is connected to the control input 37a of the fourth delivery means 37 of the first set of delivery means and connected to the control input 40a of the first delivery means 40 of the second set of delivery means.

A method for implementing the second example of the reading system is now described.

When the unlocking word 20 is stored in the second register 19, the first comparison means 50 compares a first set E60 of bits of the unlocking word 20 and a first set E50 of bits of the access key 18, the second comparison means 51 compares a second set E61 of bits of the unlocking word 20 and a second set E51 of bits of the access key 18, the third comparison means 52 compares a third set E62 of bits of the unlocking word 20 and a third set E52 of bits of the access key 18, and the fourth comparison means 53 compares a fourth set E63 of bits of the unlocking word 20 and a fourth set E53 of bits of the access key 18.

Each set of the first, second, third and fourth sets E50, E51, E52, E53 of bits of the access key 18 includes at least one bit of the plurality of the bits of the access key 18, each bit being different.

Alternatively, each set of the first, second, third and fourth sets E50, E51, E52, E53 of bits of the access key 18 includes a plurality of bits of the access key 18, the plurality of bits of each set of the first, second, third and fourth sets E50, E51, E52, E53 being different.

Next, it is assumed that the first set E50 of bits of the access key 18 comprises the bits B₄₁, B₄₂, B₄₇, B₄₈, that the second set E51 of bits of the access key 18 comprises the bits B₄₃, B₄₄, B₄₅, B₄₆, that the third set E52 of bits of the access key 18 comprises the bits B₄₁, B₄₄, B₄₅, B₄₈ and that the fourth set E53 of bits of the access key 18 comprises the bits B₄₂, B₄₃, B₄₆, B₄₇ so that the bits of each set E50, E51, E52, E53 do not follow one another.

If the first set of bits E60 of the unlocking word 20 is identical to the first set E50 of bits of the access key 18, the first comparison means 50 controls the first delivery means 34 of the first set of delivery means so that it delivers a first set E34 of bits of the first word 32 and controls the fourth delivery means 39 of the second set of delivery means so that it delivers a second set E39 of bits of the second word 33.

If the second set of bits E61 of the unlocking word 20 is identical to the second set E51 of bits of the access key 18, the second comparison means 51 controls the second delivery means 35 of the first set of delivery means so that it delivers a second set E35 of bits of the first word 32 and controls the third delivery means 38 of the second set of delivery means so that it delivers a first set E38 of bits of the second word 33.

If the third set of bits E62 of the unlocking word 20 is identical to the third set E52 of bits of the access key 18, the third comparison means 52 controls the third delivery means 36 of the first set of delivery means so that it delivers a third set E36 of bits of the first word 32 and controls the second delivery means 41 of the second set of delivery means so that it delivers a fourth set E41 of bits of the second word 33.

If the fourth set of bits E63 of the unlocking word 20 is identical to the fourth set E53 of bits of the access key 18, the fourth comparison means 53 controls the fourth delivery means 37 of the first set of delivery means so that it delivers a fourth set E37 of bits of the first word 32 and controls the first delivery means 40 of the second set of delivery means so that it delivers a third set E40 of bits of the second word 33.

The first, second, third and fourth sets E34, E35, E36, E37 of bits of the first word 32 form the first word 32 and the first, second, third and fourth sets E38, E39, E40, E41 of bits of the second word 33 form the second word 33.

For example, the sets E34, E35, E36, E37, E38, E39, E40, E41 of bits of the first and second words 32, 33 delivered by the delivery means are stored in the first register 14.

It is assumed that the first set E34 of bits of the first word 32 comprises for example the bits B₆₁, B₆₅, B₆₉, B₇₃, B₇₇, B₈₁, B₈₅, B₈₉ of the first word 32, the second set E35 of bits of the first word 32 comprises for example the bits B₆₂, B₆₆, B₇₀, B₇₄, B₇₈, B₈₂, B₈₆, B₉₀ of the first word 32, the third set E36 of bits of the first word 32 comprises for example the bits B₆₃, B₆₇, B₇₁, B₇₅, B₇₉, B₈₃, B₈₇, B₉₁ of the first word 32, and the fourth set E37 of bits of the first word 32 comprises for example the bits B₆₄, B₆₈, B₇₂, B₇₆, B₈₀, B₈₄, B₈₈, B₉₂ of the first word 32.

It is assumed that the first set E38 of bits of the second word 33 comprises for example the bits B₁₀₁, B₁₀₅, B₁₀₉, B₁₁₃, B₁₁₇, B₁₂₁, B₁₂₅, B₁₂₉ of the second word 33, the second set E39 of bits of the second words 33 comprises for example the bits B₁₀₂, B₁₀₆, B₁₁₀, B₁₁₄, B₁₁₈, B₁₂₂, B₁₂₆, B₁₃₀ of the second word 33, the third set E40 of bits of the second word 33 comprises for example the bits B₁₀₃, B₁₀₇, B₁₁₁, B₁₁₅, B₁₁₉, B₁₂₃, B₁₂₇, B₁₃₁ of the second word 33, and the fourth set E41 of bits of the second word 33 comprises for example the bits B₁₀₄, B₁₀₈, B₁₁₂, B₁₁₆, B₁₂₀, B₁₂₄, B₁₂₈, B₁₃₂ of the second word 33.

The bits of each set E34, E35, E36, E37, E38, E39, E40, E41 of the words 32, 33 do not follow one another.

Of course, alternatively, only the bits of one set or several sets E34, E35, E36, E37, E38, E39, E40, E41 of the words 32, 33 do not follow one another.

To obtain the entirety of the encryption/decryption key 10, it is necessary to meet four different conditions.

It is necessary that the bits of the first set of bits E60 of the unlocking word 20 are identical to the bits of the first set E50 of bits of the access key 18 to obtain the first set E34 of bits of the first word 32 and the second set E39 of bits of the second word 33, that the bits of the second set of bits E61 of the unlocking word 20 are identical to the bits of the second set E51 of bits of the access key 18 to obtain the second set E35 of bits of the first word 32 and the first set E38 of bits of the second word 33, that the bits of the third set of bits E62 of the unlocking word 20 are identical to the bits of the third set E52 of bits of the access key 18 to obtain the third set E36 of bits of the first word 32 and the fourth set E41 of bits of the second word 33, and that the bits of the fourth set of bits E63 of the unlocking word 20 are identical to the bits of the fourth set E53 of bits of the access key 18 to obtain the fourth set E37 of bits of the first word 32 and the third set E40 of bits of the second word 33.

During an attack, it is necessary to implement four lasers to force the delivery of the key 10 by the delivery means 34, 35, 36, 37, 38, 39, 40, 41 thereby making the reading system more robust in comparison with a reading system known from the prior art.

As described before, each of the memories 42, 43, 44, 45, 46, 47, 48, 49 may contain a series of eight bits each similar to a portion of the encryption/decryption key 10 so that when one of the delivery means 34, 35, 36, 37, 38, 39, 40, 41 is controlled to connect its output to its second input, the delivery means delivers the series of bits contained in the memory connected to the second input.

Of course, the encryption/decryption key 10 may be formed of more than two words, each word including more or less thirty-two bits.

1. A method for reading an encryption/decryption key including at least one first word comprising a plurality of bits, the method comprising:
comparing, with a first comparison, a first set of bits of an unlocking word including a plurality of bits and of a first set of bits of an access key, the first set of bits of the access key including at least one first bit of the plurality of bits of the access key;
delivering at least one first set of bits of the first word of the encryption/decryption key if the first set of bits of the unlocking word is identical to the first set of bits of the access key, the first set of bits being selected from among the plurality of bits of the first word;
comparing, with at least one second comparison, a second set of bits of the unlocking word different from the first set of bits of the unlocking word and of a second set of bits of the access key, the second set of bits of the access key including at least one second bit of the plurality of bits of the access key different from the first bit; and
delivering at least one second set of bits of the first word of the encryption/decryption key if the second set of bits of the unlocking word is identical to the second set of bits of the access key, the second set of bits being selected from among the plurality of bits of the first word and different from the bits of the first set of bits, a combination of the sets of bits of the first word forming the first word.

2. The method of claim 1, the encryption/decryption key including at least one second word comprising a plurality of bits, the method further comprising:
delivering at least one first set of bits of the second word of the encryption/decryption key when the first set of bits of the unlocking word is identical to the first set of bits of the access key, the first set of bits of the second word being selected from among the plurality of bits of the second word; and
delivering at least one second set of bits of the second word of the encryption/decryption key if the second set of bits of the unlocking word is identical to the second set of bits of the access key, the second set of bits of the second word being selected from among the plurality of bits of the second word and different from the bits of the first set of bits of the second word, a combination of the sets of bits of the second word forming the second word and the first word and the second word forming the encryption/decryption key.

3. The method of claim 1, wherein the bits of at least one set of bits of the encryption/decryption key are selected so that the bits do not follow one another.

4. The method of claim 1, wherein when a set of bits of the unlocking word is not identical to a set of bits of the access key, the method further comprising delivering a set of predetermined bits having the same size as the set of bits associated with a comparison.

5. The method of claim 1, wherein the first set of bits of the access key includes the first bit of the access key and a first combination of bits selected from among the plurality of bits of the access key, the bits of the first combination being different from the first and second bits of the access key, and the second set of bits of the access key includes the second bit and a second combination of bits selected from among the plurality of bits of the unlocking word, the bits of the second combination being different from the first bit, from the second bit and from the bits of the first combination.

6. A system for reading an encryption/decryption key including at least one first word comprising a plurality of bits, the system comprising:
a first comparison means configured to compare a first set of bits of an unlocking word including a plurality of bits and of a first set of bits of an access key, the first set of bits of the access key including at least one first bit of the plurality of bits of the access key;
a first delivery means configured to deliver at least one first set of bits of the first word of the encryption/decryption key if the first set of bits of the unlocking word is identical to the first set of bits of the access key, the first set of bits being selected from among the plurality of bits of the first word;
a second comparison means configured to compare a second set of bits of the unlocking word different from the first set of bits of the unlocking word and of a second set of bits of the access key, the second set of bits of the access key including at least one second bit of the plurality of bits of the access key different from the first bit; and
a second delivery means configured to deliver at least one second set of bits of the first word of the encryption/decryption key if the second set of bits of the unlocking word is identical to the second set of bits of the access key, the second set of bits being selected from among the plurality of bits of the first word and different from the bits of the first set of bits, a combination of the sets of bits of the first word forming the first word.

7. The system of claim 6, the encryption/decryption key including at least one second word comprising a plurality of bits, the system further comprising:
a third delivery means configured to deliver at least one first set of bits of the second word of the encryption/decryption key if the first set of bits of the unlocking word is identical to the first set of bits of the access key, the first set of bits being selected from among the plurality of bits of the first word; and
a fourth delivery means configured to deliver at least one second set of bits of the second word of the encryption/decryption key if the second set of bits of the unlocking word is identical to the second set of bits of the access key, the second set of bits being selected from among the plurality of bits of the first word and different from the bits of the first set of bits, a combination of the sets of bits of the second word forming the first word.

8. The system of claim 6, wherein the bits of at least one set of bits of the encryption/decryption key are selected so that the bits do not follow one another.

9. The system of claim 6, wherein at least one delivery means is configured to deliver a set of predetermined bits when the set of bits of the unlocking word associated with the delivery means is not identical to a set of bits of the access key, the set of predetermined bits having the same size as the set of bits associated with a comparison.

10. The system of claim 6, wherein the first set of bits of the access key includes the first bit of the access key and a first combination of bits selected from among the plurality of bits of the access key, the bits of the first combination being different from the first and second bits of the access key, and the second set of bits of the access key includes the second bit and a second combination of bits selected from among the plurality of bits of the unlocking word, the bits of the second combination being different from the first bit, from the second bit and from the bits of the first combination.
